(19) United States
(12) Patent Application Publication
(10) Pub. No.: US 2004/0068442 A1
(43) Pub. Date: Apr. 8, 2004

(54) Method and system of locating and selling pre-owned vehicles

(76) Inventor: James P. Ertle, Kunkletown, PA (US)

Correspondence Address: RATNERPRESTIA, P O BOX 980, VALLEY FORGE, PA, 19482-0980, US

(21) Appl. No.: 10/264,620

(22) Filed: Oct. 4, 2002

(51) Int. Cl. G06F 17/60

(52) U.S. Cl. 705/26

(57) ABSTRACT

A method for operating a franchise network of vehicle dealers selling pre-owned vehicles. The franchise dealers have access, through the intermediacy of a coordinating franchisor, to vehicles in inventory at other dealers' locations, and can thereby fill a higher percentage of customer vehicle requests. In addition, the coordinating franchiser routes information about customer vehicle requests to franchise dealers by matching their geographic locations with those of the customers, whose names and vehicle requests are received by the franchisor.

### FIELD OF THE INVENTION

The present invention relates generally to a method and system of selling vehicles and, more particularly, to a method and system of operating a franchise network of dealers selling pre-owned vehicles, in which a franchiser coordinates and distributes information regarding available vehicles and potential customers to franchise dealers.

### BACKGROUND OF THE INVENTION

The market for pre-owned vehicles is a fragmented one, characterized by a large number of small, independent dealers who each keep an inventory of vehicles that they hope to match with potential customers. Such dealers are hampered because their inventories are of necessity relatively small and their access to potential customers with which to make a match is limited. Moreover, inventory of a given dealer does not always comprise only vehicles that the dealer would like to have on hand. Rather, some of the vehicles may be trade-ins for which the dealer has no ready market, but which the dealer accepts as part of another transaction. The dealer may attempt to address these issues by hiring a salaried wholesale buyer-seller. This is an expensive solution, however, for all but the largest dealers. These problems lead to considerable inefficiency in trying to sell vehicles, with the result that there is a tendency for vehicles to remain in inventory for extended periods of time, tying up inventory capital.

At the same time, consumers looking to purchase a vehicle according to their specifications are faced with the task of trying to search, either in person, through advertisements, or on the Internet, the inventories of each of these numerous small dealers. The result is a considerable expenditure of time, and (frequently) less than a perfect vehicle match.

As a result of these and other problems, efforts have been made to improve the process of buying and selling pre-owned vehicles by use of electronic information systems, particularly including network-based solutions. Frequently, but not always, these involve use of the Internet to manage the transfer of information.

For example, Wolfe et al disclose in U.S. Pat. No. 6,282,517 a method and apparatus for formulating and submitting a purchase request over a computer network, and making the purchase request available to a dealer immediately. The method involves a data center system having a system database, a buyer interface, and a dealer interface. The system database includes an exclusive database region for each participating dealer. A potential buyer submits a purchase request over a computer network to the data center system. The purchase request includes a product identification data and a buyer location information. The data center system further contains dealer information, product information, and the like. The data center system determines at least one appropriate dealer to receive the purchase request. The data center creates a purchase request record from the data and information provided in the purchase request. The data center then communicates the purchase request to the appropriate dealer by immediately storing the purchase request record into the appropriate dealer's exclusive database region. Thus, the purchase request record becomes immediately available to the appropriate dealer.

In U.S. Published Patent Application No. 2001/0049653 A1, Sheets describes a system for matching customers with products in inventory that will be desirable and affordable to the customers. The system affords the ability to store information about multiple products in a product database, and information about multiple customers in a customer database. The system then matches particular products in the product database with particular customers in the customer database, based upon matching multiple search criteria fields associated with products and customers. The system also has the ability to generate net prices for each product (i.e., total price or total monthly payment amounts) based upon the qualifications of the particular customer, and limit the number of products matched with the particular customer based upon the customer's desired total payment or desired monthly payments. By generating reports that integrate customer/product matches with net price information, the system seeks to provide effective and efficient shopping by customers.

Wakabayashi et al, in U.S. Published Patent Application No. 2001/0054017 A1, disclose an information processing technology designed to speed up a process in which a prospective buyer expresses the intention to purchase a pre-owned car. A car sale information-providing system comprises a car information storage unit containing mappings of information (including name, type, model year, etc.) about a car to car inspection information, which is obtained as a result of inspecting the car concerned. Also included is a car information input device for inputting and outputting the car information stored in the car information storage unit, a search unit for outputting an input screen for searching the car information stored in the car information storage unit based on conditions inputted, and a car information output unit for outputting display information. The system includes a purchase indication interface for transmitting car purchase information containing the searched car information and the car inspection information corresponding to the car information.

In U.S. Pat. No. 6,041,310, Green et al. describe a method and system for facilitating a transaction between a customer and an automobile dealership. The system includes a kiosk including an input/display terminal and a terminal processor for formulating a multilevel customer query of automobile inventory. The query searches a storage device containing automobile data and images to return a selected inventory to the input/display device. The method includes storing customer data, selected inventory information for later access by a marketing follow-up application, and a financing and insurance application.

Despite these and other advances, there continues to be a need for improving the efficiency of finding suitable matches between customers and available vehicles representing a variety of dealerships and locations, and for coordinating communication and activities among multiple parties to bring about a successful purchase and sale of a pre-owned vehicle.

### SUMMARY OF THE INVENTION

To meet this and other needs, and in view of its purposes, the present invention provides a method and system of operating a franchise network of pre-owned vehicle dealers in which a franchisor coordinates and distributes information regarding available vehicles and potential customers to franchise dealers. In one aspect, the present invention is a method for a franchisor to sell an inventory vehicle, the method comprising the steps of:

(a) receiving, from a seller owning an inventory vehicle, seller information and inventory vehicle information about the inventory vehicle,

(b) receiving from a first franchisee a request for the inventory vehicle information,

(c) providing to the first franchisee the inventory vehicle information,

(d) receiving from the first franchisee a first purchase request for the inventory vehicle,

(e) sending to the seller a second purchase request for the inventory vehicle,

(f) purchasing the inventory vehicle from the seller, and

(g) selling the inventory vehicle to the first franchisee.

In another aspect, the invention is a method for a franchisor to sell an inventory vehicle, the method comprising the steps of:

(a) providing a vehicle database including seller information about a seller and inventory vehicle information about an inventory vehicle owned by the seller;

(b) providing a first interactive interface, accessible via a computer information network, for use by the seller;

(c) providing a second interactive interface, accessible via the computer information network, for use by a first franchisee;

(d) receiving, from the seller via the first interactive interface and the computer information network, the seller information and the inventory vehicle information;

(e) storing the seller information and the inventory vehicle information in the vehicle database;

(f) receiving from the first franchisee via the second interactive interface and the computer information network, a request for the inventory vehicle information;

(g) sending to the first franchisee via the second interactive interface and the computer information network, the inventory vehicle information;

(h) receiving from the first franchisee via the second interactive interface and the computer information network, a first purchase request for the inventory vehicle;

(i) sending to the seller via the first interactive interface and the computer information network, a second purchase request for the inventory vehicle;

(j) purchasing the inventory vehicle from the seller; and

(k) selling the inventory vehicle to the first franchisee,

wherein the franchisor is in communication with the first franchisee via the second interactive interface and the computer information network, and in communication with the vehicle database.

In still another aspect, the invention is a system for use by a franchisor in selling an inventory vehicle, the system comprising:

(a) means for storing seller information about a seller and inventory vehicle information about an inventory vehicle owned by the seller;

(b) means for receiving from a first franchisee a request for the inventory vehicle information;

(c) means for receiving, from a seller, the seller information and the inventory vehicle information;

(d) means for sending to the first franchisee the inventory vehicle information;

(e) means for receiving from the first franchisee a first purchase request for the inventory vehicle; and

(f) means for sending to the seller a second purchase request for the inventory vehicle.

In a further aspect, the invention is a system for use by a franchisor to sell an inventory vehicle, the system comprising:

(a) a vehicle database including seller information about a seller and inventory vehicle information about an inventory vehicle owned by the seller;

(b) a first interactive interface, accessible via a computer information network, for use by the seller; and

(c) a second interactive interface, accessible via the computer information network, for use by a first franchisee,

wherein the franchisor is in communication with the first franchisee via the second interactive interface and the computer information network, and in communication with the vehicle database.

It is to be understood that both the foregoing general description and the following detailed description are exemplary, but are not restrictive, of the invention.

### BRIEF DESCRIPTION OF DRAWING

The invention is best understood from the following detailed description when read in connection with the accompanying drawing. Included in the drawing is the following figure:

FIG. 1 is a flow chart detailing steps in a method of locating and selling vehicles in accordance with the invention.

### DETAILED DESCRIPTION OF THE INVENTION

The invention will next be described with reference to the figure. The figure is intended to be illustrative rather than limiting and is included to facilitate the explanation of the present invention. Also, it is to be understood that, when mention is made of communication between the franchisor, any of the franchisees, the seller, and/or the customer, such communication may be done with direct action by a person, or may be partially or completely accomplished using automatic response systems incorporated into or working in concert with the databases and interactive interfaces to be described below. Such communication may nonexclusively involve, for example, sending and receiving of information, specifications, requests for information, and/or purchase requests.

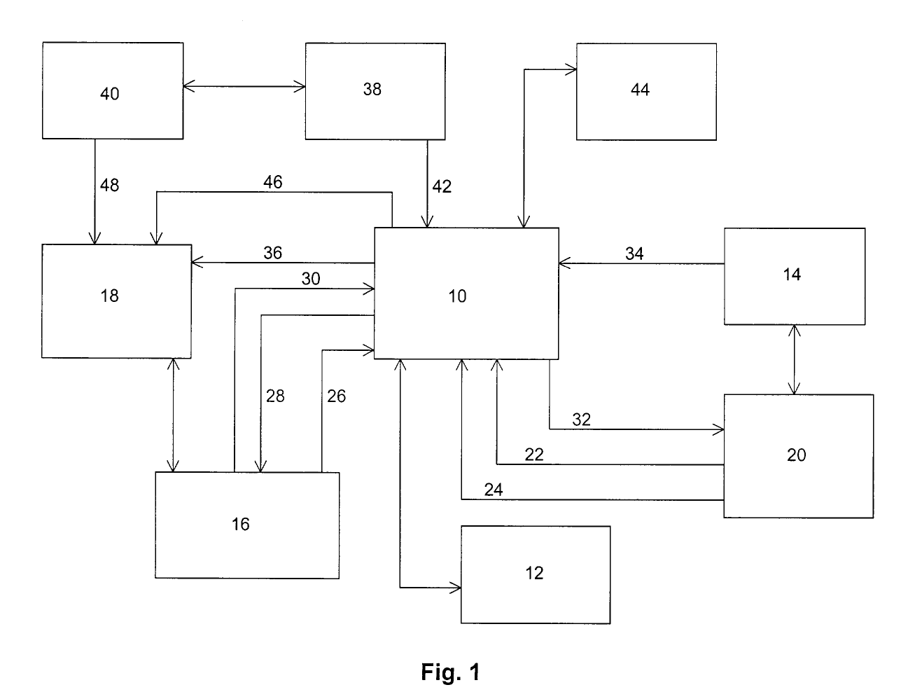

Referring now to FIG. 1, there is shown a flow chart of activities relating to a method for a franchiser 10 to sell an inventory vehicle (not shown), according to one embodiment of the invention. As used in this document, “inventory vehicle” means a vehicle, owned by a seller 14, which the seller 14 desires to sell. The franchisor provides, and is in communication with, a vehicle database 12 comprising seller information about the seller 14 and inventory vehicle information about the inventory vehicle. Typically, the database 12 will hold information about a plurality of sellers and inventory vehicles.

In addition, the franchiser 10 provides a first interactive interface 20, accessed by the seller 14 via a computer information network (not shown), for use by the seller 14 in communicating with the franchiser 10. The first interactive interface 20 is resident on a computer owned or accessed by the franchiser 10. The computer information network may for example be the Internet, or a Local Area Network, or a Wide Area Network, or a combination of any of these, or any other form of computer communication network. The computer information network is typically accessed by logging in from a remote computer.

In one embodiment of the invention, the franchiser 10 may receive from the seller 14, via the first interactive interface 20, seller information 22 and inventory vehicle information 24, which are stored in a vehicle database 12. The seller information 22 may include for example the seller's name, address, telephone number, electronic-mail address, credit information, and additional contact information. The inventory vehicle information 24 may include an indication of availability, vehicle make, model, model year, color, vehicle options, series, transmission type, mileage, physical condition, and asking price.

The franchisor 10 also provides a second interactive interface 16, resident on a computer owned or accessed by the franchisor 10. The second interactive interface 16 may be accessed by a first franchisee 18, via the computer information network, to communicate with the franchisor 10.

At least one, and preferably a plurality of, franchisees are associated with the franchisor 10. Each franchisee may buy vehicles from other franchisees and/or sell vehicles to them as well. Accordingly, the seller 14 may be a franchisee. Typically, all franchisees will therefore provide the vehicle database 12 with seller information 22 and inventory vehicle information 24 on all vehicles in their own inventory. Alternatively, the seller 14 may be an individual or a representative of a selling entity not associated with the franchisor 10, for example a representative of a car rental agency or a bank with vehicles that are desired to be sold.

In one embodiment of the invention, a retail customer 40 may make direct contact 48 with a first franchisee 18. Such direct contact 48 may be made, for example, by telephone or by walking into a showroom. Thus, the retail customer 40 may provide, via the direct contact 48, customer information and specifications for a desired vehicle. Customer information may include the customer's name, address, phone number, electronic-mail address, credit information, additional contact information, method of payment desired, trade-in information, preferences for a particular franchisee with whom to deal, preferences for dealing with a franchisee in a particular geographic location, and the like. Specifications for a desired vehicle may include an indication of availability, vehicle make, model, model year, color, vehicle options, series, transmission type, mileage, physical condition, price ceiling, and the like. The retail customer 40 may be an individual looking for a vehicle, or may represent a purchasing entity such as a vehicle dealer not having a franchise relationship with the franchisor 10.

When the first franchisee 18 finds that a desired vehicle is not in the inventory of the first franchisee 18, but wishes to obtain the vehicle for sale to the customer 40, a search may be conducted of the vehicle database 12 via the second interactive interface 16 for a vehicle that will match the desired vehicle specifications of the customer 40. This search may be done by first franchisee 18 sending a request 26 for inventory vehicle information 24 to the franchisor 10, to determine the availability of an appropriate vehicle. If a match is found, the franchisor 10 may send information 28 on the matching vehicle or vehicles to the first franchisee 18 via the second interactive interface 16. If the first franchisee 18 is satisfied with the vehicle information, the franchisor 10 may receive from the first franchisee 18 via the second interactive interface 16 a first purchase request 30 for the inventory vehicle.

The franchisor 10 may then send to the seller 14 via the first interactive interface 20 a second purchase request 32 for the inventory vehicle, which the franchisor 10 may then purchase 34 from the seller 14 and subsequently sell 36 to the first franchisee 18. Optionally, according to another embodiment of the invention, the sale 36 may comprise the franchisor 10 picking up the desired vehicle at the location where the seller 14 is keeping it, and/or delivering the vehicle to the first franchisee 18. Also optionally, the sale 36 may comprise the franchisor 10 delivering the ownership title for the vehicle to the first franchisee 18. The purchase 34, sale 36, and/or delivery of the vehicle to the first franchisee 18 may be performed by any commonly practiced method.

Using the arrangement described above, the first franchisee 18 has the ability to access a large distributed inventory of vehicles, coordinated by the franchisor 10, to meet customer needs. The first franchisee 18 also has a broader market for his or her own inventory of vehicles, by virtue of making that inventory accessible to other franchisees in their efforts to find suitable vehicles for their own customers.

In addition, the franchisor 10 may also provide the first franchisee 18 other infrastructure-related support. Such support may include, for example, vehicle history reports, sales training, training on effective policies and procedures for running a pre-owned vehicle sales operation and a tracking system for vehicles, vehicle sales, and sales prospects. Support may also be provided for customer satisfaction follow-up, and marketing tools such as access to market information, advertising consulting, advertising guidelines and artwork for newspaper, billboard, Internet, radio, television, and other advertising forms. Also provided may be software for analyzing that information, training, accounting software, finance and insurance software, and vehicle certification standards. The franchisor 10 may profit by marking up the vehicle as it passes through the hands of the franchisor 10 or by extracting franchise fees from the franchise dealers in exchange for the services provided by the franchisor 10.

In another embodiment of the invention, and as further shown in FIG. 1, the franchisor 10 may provide a third interactive interface 38, accessed by a customer 40 via the computer information network, for use by customer 40 in communicating with the franchisor 10. The third interactive interface 38 is resident on a computer owned or accessed by the franchisor 10. The franchisor 10 may receive 42, from the customer 40, customer information and specifications for a desired vehicle. This information (not shown) may be stored in a customer database 44, which is provided by and in communication with the franchisor 10.

In one embodiment of the invention, the franchisor 10 may send 46 this customer information and specifications for the desired vehicle to the first franchisee 18, via the second interactive interface 16, if and only if the customer 40 is located in a geographic area of responsibility (not shown) assigned to the first franchisee 18. Alternatively, if customer 40 has provided franchisor 10 with a preference for dealing with one or more specific franchisees, or franchisees in a particular geographic area, franchisor 10 may send the customer information and desired vehicle specifications to franchisees meeting the criteria set forth by customer 40. Still other criteria may be established by franchisor 10 to determine which franchisee or franchisees will receive customer information and desired vehicle specifications supplied by customer 40. Franchisees not meeting the criteria set forth by franchisor 10 typically will not have access to this information and specifications.

In yet another embodiment of the invention, the first franchisee 18 may be a retail sales department owned by the franchisor 10, and may optionally carry its own inventory of vehicles. In the case where the franchisor 10 owns the first franchisee 18, the sale 36 may involve an actual exchange of money or may comprise an accounting transaction internal to the franchisor 10 in which the vehicle is transferred from one department to another.

In addition, franchisor 10 may provide franchisee 18 and/or other franchisees with software, electronic or paper forms for use by the franchisee in support of its business, the services of a representative to counsel the franchisee regarding effective practices and policies, and other aids to the franchisee's business. These may be provided with or without specific individual billing charges being made to the franchisee.

The present invention can further be embodied in the form of computer-implemented processes and apparatus for practicing such processes, for example, and can be embodied in the form of computer program code embodied in tangible media, such as floppy diskettes, fixed (hard) drives, CD ROM's, magnetic tape, fixed-integrated circuit devices, or any other computer-readable storage medium, such that when the computer program code is loaded into and executed by a computer, the computer becomes an apparatus for practicing the invention.

Although illustrated and described above with reference to certain specific embodiments, the present invention is nevertheless not intended to be limited to the details shown. Rather, various modifications may be made in the details within the scope and range of equivalents of the claims and without departing from the spirit of the invention.

What is claimed:

1. A method for a franchisor to sell an inventory vehicle, the method comprising the steps of:
(a) receiving, from a seller owning an inventory vehicle, seller information and inventory vehicle information about the inventory vehicle;
(b) receiving from a first franchisee a request for the inventory vehicle information;
(c) providing to the first franchisee the inventory vehicle information;
(d) receiving from the first franchisee a first purchase request for the inventory vehicle;
(e) sending to the seller a second purchase request for the inventory vehicle;
(f) purchasing the inventory vehicle from the seller; and
(g) selling the inventory vehicle to the first franchisee.

2. The method of claim 1 further comprising:
(h) receiving, from a customer, customer information and specifications for a desired vehicle; and
(i) providing to the first franchisee the customer information and the specifications for the desired vehicle;
wherein the first franchisee meets one or more selection criteria set forth by the franchisor.

3. The method of claim 2 wherein said one or more selection criteria comprises a requirement that the customer be located in a geographic area of responsibility assigned by the franchisor to the first franchisee.

4. The method of claim 1 wherein a customer provides the first franchisee with customer information and specifications for a desired vehicle.

5. The method of claim 1 comprising providing a plurality of franchisees, wherein the seller is one of the plurality of franchisees.

6. The method of claim 1 further comprising delivering the inventory vehicle to the first franchisee.

7. The method of claim 1 wherein the franchisor owns the first franchisee, and wherein the first franchisee sells the inventory vehicle to a customer.

8. A method for a franchisor to sell an inventory vehicle, the method comprising the steps of:
(a) providing a vehicle database including seller information about a seller and inventory vehicle information about an inventory vehicle owned by the seller;
(b) providing a first interactive interface, accessible via a computer information network, for use by the seller;
(c) providing a second interactive interface, accessible via the computer information network, for use by a first franchisee;
(d) receiving, from the seller via the first interactive interface and the computer information network, the seller information and the inventory vehicle information;
(e) storing the seller information and the inventory vehicle information in the vehicle database;
(f) receiving from the first franchisee via the second interactive interface and the computer information network, a request for the inventory vehicle information;
(g) sending to the first franchisee via the second interactive interface and the computer information network, the inventory vehicle information;
(h) receiving from the first franchisee via the second interactive interface and the computer information network, a first purchase request for the inventory vehicle;
(i) sending to the seller via the first interactive interface and the computer information network, a second purchase request for the inventory vehicle;
(j) purchasing the inventory vehicle from the seller; and
(k) selling the inventory vehicle to the first franchisee;
wherein the franchisor is in communication with the first franchisee via the second interactive interface and the computer information network, and in communication with the vehicle database.

9. The method of claim 8 further comprising:
(l) providing a third interactive interface, accessible via the computer information network, for use by a customer;
(m) receiving from the customer, via the third interactive interface and the computer information network, customer information and specifications for a desired vehicle;
(n) storing, in a customer database, the customer information and the specifications for the desired vehicle; and
(o) sending to the first franchisee, via the second interactive interface and the computer information network, the customer information and the specifications for the desired vehicle;
wherein the first franchisee meets one or more selection criteria set forth by the franchisor, and the franchisor is in communication with the third interactive interface and in communication with the customer database.

10. The method of claim 9 wherein said one or more selection criteria comprises a requirement that the customer be located in a geographic area of responsibility assigned by the franchisor to the first franchisee.

11. The method of claim 8 wherein a customer provides the first franchisee with customer information and specifications for a desired vehicle.

12. The method of claim 8 further comprising providing a plurality of franchisees, said plurality of franchisees including the seller and the first franchisee.

13. The method of claim 8 further comprising delivering the inventory vehicle to the first franchisee.

14. The method of claim 8 wherein the franchisor owns the first franchisee, and wherein the first franchisee sells the inventory vehicle to a customer.

15. A system for use by a franchisor in selling an inventory vehicle, the system comprising:
(a) means for storing seller information about a seller, and inventory vehicle information about an inventory vehicle owned by the seller;
(b) means for receiving from a first franchisee a request for the inventory vehicle information;
(c) means for receiving, from a seller, the seller information and the inventory vehicle information;
(d) means for sending to the first franchisee the inventory vehicle information;
(e) means for receiving from the first franchisee a first purchase request for the inventory vehicle; and
(f) means for sending to the seller a second purchase request for the inventory vehicle.

16. The system of claim 15 further comprising:
(i) means for receiving, from a customer, customer information and specifications for a desired vehicle; and
(j) means for providing to the first franchisee the customer information and the specifications for the desired vehicle;
wherein the first franchisee meets one or more selection criteria set forth by the franchisor.

17. The system of claim 16 wherein said one or more selection criteria comprises a requirement that the customer be located in a geographic area of responsibility assigned by the franchisor to the first franchisee.

18. The system of claim 15 wherein a customer provides the first franchisee with customer information and specifications for a desired vehicle.

19. The system of claim 15 further comprising a plurality of franchisees, said plurality of franchisees including the seller and the first franchisee.

20. The system of claim 15 wherein the franchisor owns the first franchisee, and wherein the first franchisee sells the inventory vehicle to a customer.

21. A system for use by a franchisor to sell an inventory vehicle, the system comprising:
(a) a vehicle database including seller information about a seller and inventory vehicle information about an inventory vehicle owned by the seller;
(b) a first interactive interface, accessible via a computer information network, for use by the seller; and
(c) a second interactive interface, accessible via the computer information network, for use by a first franchisee;
wherein the franchisor is in communication with the first franchisee via the second interactive interface and the computer information network, and in communication with the vehicle database.

22. The system of claim 22 further comprising:
(d) a third interactive interface, accessible via the computer information network, for use by a customer; and
(e) a customer database comprising customer information and specifications for a desired vehicle;
wherein the first franchisee meets one or more selection criteria set forth by the franchisor, and the franchisor is in communication with the third interactive interface and in communication with the customer database.

23. The system of claim 23 wherein said one or more selection criteria comprises a requirement that the customer be located in a geographic area of responsibility assigned by the franchisor to the first franchisee.

24. The system of claim 22 further comprising a plurality of franchisees, said plurality of franchisees including the seller and the first franchisee

25. The system of claim 22 further comprising means for delivering the inventory vehicle to the first franchisee.

26. The system of claim 22 wherein the franchisor owns the first franchisee, and wherein the first franchisee sells the inventory vehicle to a customer.

27. A method for a franchisor to sell an inventory vehicle, the method comprising the steps of:
(a) providing a vehicle database including seller information about a seller who is one of a plurality of franchisees, and inventory vehicle information about an inventory vehicle owned by the seller;
(b) providing a first interactive interface, accessible via a computer information network, for use by the seller;
(c) providing a second interactive interface, accessible via the computer information network, for use by a first franchisee who is one of said plurality of franchisees;
(d) receiving, from the seller via the first interactive interface and the computer information network, the seller information and the inventory vehicle information;
(e) storing the seller information and the inventory vehicle information in the vehicle database;
(f) receiving from the first franchisee via the second interactive interface and the computer information network, a request for the inventory vehicle information;
(g) sending to the first franchisee via the second interactive interface and the computer information network, the inventory vehicle information;
(h) receiving from the first franchisee via the second interactive interface and the computer information network, a first purchase request for the inventory vehicle;
(i) sending to the seller via the first interactive interface and the computer information network, a second purchase request for the inventory vehicle;
(j) purchasing the inventory vehicle from the seller;
(k) selling the inventory vehicle to the first franchisee;
(l) delivering the inventory vehicle to the first franchisee;
(l) providing a third interactive interface, accessible via the computer information network, for use by a customer;
(m) receiving from the customer via the third interactive interface and the computer information network, customer information and specifications for a desired vehicle;
(n) storing, in a customer database, the customer information and the specifications for the desired vehicle; and
(o) sending to the first franchisee via the second interactive interface and the computer information network, the customer information and the specifications for the desired vehicle;
wherein the customer is located in a geographic area of responsibility assigned to the first franchisee, the franchisor is in communication with the third interactive interface and with the customer database and the vehicle database, and the franchisor is in communication with the first franchisee via the second interactive interface and the computer information network.
